(19) United States
(12) Patent Application Publication
(10) Pub. No.: US 2016/0280190 A1
(43) Pub. Date: Sep. 29, 2016

(54) PRE-COMPUTED AND OPTIONALLY CACHED COLLISION MITIGATION BRAKING SYSTEM

(71) Applicant: Martin P. Franz, Portage, MI (US)

(72) Inventor: Martin P. Franz, Portage, MI (US)

(73) Assignee: BENDIX COMMERCIAL VEHICLE SYSTEMS LLC, Elyria, OH (US)

(21) Appl. No.: 14/665,001

(22) Filed: Mar. 23, 2015

(51) Int. Cl. B60T 7/22; B60Q 9/00; G08G 1/16

(52) U.S. Cl. CPC B60T 7/22; G08G 1/16; B60Q 9/008

(57) ABSTRACT

When mitigating collisions between a host vehicle and a forward vehicle, the forward vehicle is monitored and real-time data regarding distance and relative acceleration between the host and forward vehicles is used to continuously calculate a collision probability. The collision probability is used to calculate a deceleration request value sufficient to slow or stop the host vehicle within the following distance to the forward vehicle. The deceleration request value is transmitted to an antilock braking system (ABS) controller that caches the most-recently received value for execution upon receipt of an execution command. When the collision probability exceeds a first threshold, the ABS is instructed to arm the braking system. Upon detection of a brake pedal engagement, the ABS executes the brake request with the currently-cached value.

### BACKGROUND

The present application finds particular application in vehicle collision mitigation systems. However, it will be appreciated that the described techniques may also find application in other collision mitigation systems, other vehicle safety systems, or other vehicle braking systems.

Conventional approaches to collision mitigation relate to pre-charging a braking system based on the threat of a collision. By reducing an initial delay in converting driver brake pressure into brake torque, the stopping distance of the vehicle can be shortened to avoid any collision.

Fully automatic collision mitigation braking systems require a number of inputs and accurate sensor readings to function properly. There is always the problem of false alerts causing braking Many of these systems brake late in a collision scenario to avoid this problem.

Controlling vehicle foundation brakes using radar requires a much higher accuracy of target classification than conventional collision warning systems (CWS) and adaptive cruise control (ACC) systems can provide. Such systems provide a collision warning only, which is typically based on a computed probability that the host vehicle can stop within the distance by which it follows a forward vehicle. Even collision mitigation (CMT) braking systems rely on a very high probably of collision before applying the brakes. Stationary targets typically need to be properly resolved without false alerts. This can be done with radar merged with a vision system, or another source of detection, but such approaches are cost-prohibitive. The present innovation provides new and improved systems and methods that facilitate mitigating collisions between vehicles, which overcome the above-referenced problems and others.

### SUMMARY

In accordance with one aspect, a system that facilitates mitigating collisions between a host vehicle and a forward vehicle by caching a current deceleration request value for execution upon detection of a probable collision and a brake pedal signal comprises a forward sensor configured to monitor the forward vehicle, and a brake force determination module comprising a collision warning module configured to calculate a probability of a collision between the host vehicle and the forward vehicle as a function of real-time data received from the forward sensor and determine whether the calculated collision probability is above a first predetermined threshold. The brake force determination module further comprises a deceleration calculation module configured to generate a deceleration request value indicative of a brake force sufficient to mitigate the collision as a function of the calculated collision probability. The brake force determination module continuously transmits a current deceleration request value to an antilock braking system controller, where the current deceleration request value is cached for execution upon detection of the brake pedal engagement.

In accordance with another aspect, a device that facilitates mitigating collisions between a host vehicle and a forward vehicle comprises a collision warning module configured to calculate a probability of a collision between the host vehicle and the forward vehicle as a function of real-time data received from a forward sensor and determine whether the calculated collision probability is above a first predetermined threshold. The device further comprises a deceleration calculation module configured to generate a deceleration request value indicative of a brake force sufficient to mitigate the collision as a function of the calculated collision probability. The device further comprises a processor transmits a current deceleration request value to an antilock braking system controller, where the current deceleration request value is cached for execution upon detection of the brake pedal engagement.

In accordance with another aspect, a method of mitigating collisions between a host vehicle and a forward vehicle comprises monitoring a forward vehicle, calculating a probability of a collision between the forward vehicle and the host vehicle, calculating a deceleration request value indicative of a braking force sufficient to mitigate the collision, and transmitting current deceleration request values to an antilock braking system (ABS) controller for storage in a memory cache in the ABS controller. The method further comprises determining whether a first collision probability threshold has been exceeded, and upon determining that the first collision probability threshold has been exceeded, determining whether a brake pedal engagement signal has been detected. The method further comprises, upon detection of the brake pedal engagement signal, executing a braking request using the cached deceleration request value. In accordance with another aspect, an apparatus that facilitates mitigating collisions between a host vehicle and a forward vehicle comprises brake controller means for detecting a brake pedal engagement signal, collision probability calculation means for calculating a probability of a collision between the host vehicle and the forward vehicle as a function of real-time data received from a forward sensor and for determining whether the calculated collision probability is above a first predetermined threshold, and deceleration calculation means for generating a deceleration request value indicative of a brake force sufficient to mitigate the collision as a function of the calculated collision probability. The apparatus further comprises processing means that transmits a current deceleration request value to the brake controller means, where the current deceleration request value is cached for enforcement upon detection of the brake pedal engagement.

One advantage is that deceleration request message time is reduced.

Another advantage is that vehicle response time is reduced.

Still further advantages of the subject innovation will be appreciated by those of ordinary skill in the art upon reading and understanding the following detailed description.

### BRIEF DESCRIPTION OF THE DRAWINGS

The innovation may take form in various components and arrangements of components, and in various steps and arrangements of steps. The drawings are only for purposes of illustrating various aspects and are not to be construed as limiting the invention.

FIG. 1 illustrates a system that facilitates mitigating collisions between vehicles by caching a current deceleration request value for execution upon detection of a probable collision and an insufficient brake pedal signal, in accordance with various aspects set forth herein.

FIG. 2 illustrates a graph of warning modalities plotted against collision probability as it increases with time, in accordance with one or more features described herein.

FIG. 3 is a graph showing how collision probability is used to arm, trigger, and/or disarm the braking system, in accordance with one or more features described herein.

FIG. 4 illustrates a method for mitigating collisions between vehicles by caching a current deceleration request value for execution upon detection of a probable collision and an insufficient brake pedal signal, in accordance with various aspects set forth herein.

### DETAILED DESCRIPTION

The foregoing problems are overcome by the herein-described systems and methods, which facilitate updating and caching a deceleration request based on the distance to the forward vehicle and characteristics of the stopping distance of the host vehicle. When the host vehicle detects a probable collision the cached deceleration request is used when the driver steps on the brakes with a force less than is needed to achieve the cached deceleration.

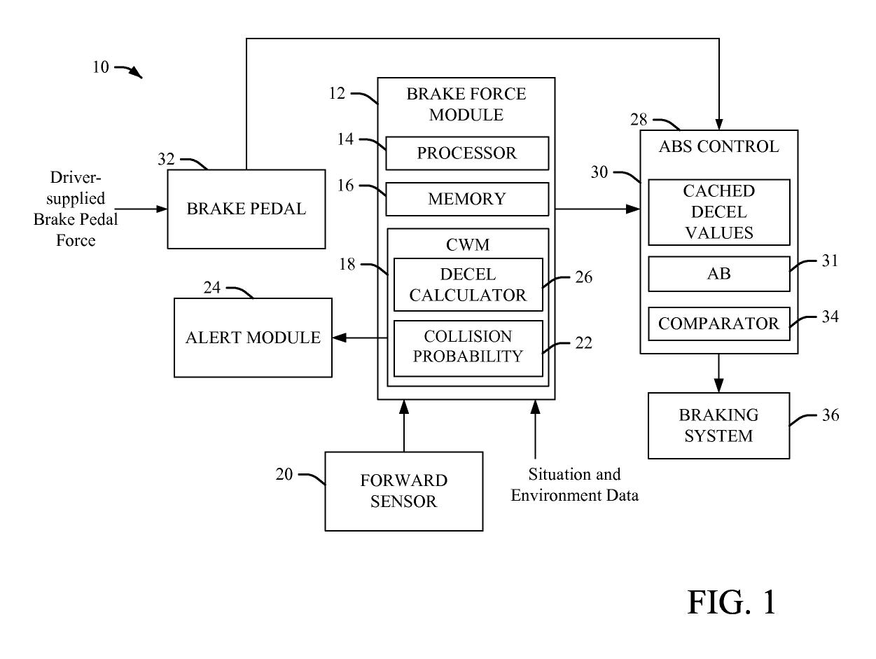

FIG. 1 illustrates a system 10 that facilitates mitigating collisions between vehicles by caching a current deceleration request value for execution upon detection of a probable collision and a brake pedal signal indicating a braking force desired by the driver less than the force needed to mitigate a collision, in accordance with various aspects set forth herein. The system includes a brake force determination module 12, which comprises a processor 14 that executes, and a memory 16 that stores, computer-executable instructions (e.g., modules, routines, programs, applications, etc.) for performing the various methods, techniques protocols, etc., described herein. The memory 16 may include volatile memory, non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), variants of the foregoing memory types, combinations thereof, and/or any other type(s) of memory suitable for providing the described functionality and/or storing computer-executable instructions for execution by the processor 14. Additionally, “module,” as used herein denotes a set of computer-executable instructions (e.g., a routine, sub-routine, program, application, or the like) that is persistently stored on the computer-readable medium or memory for execution by the processor.

A collision warning module (CWM) 18 receives data from a forward sensor 20 (e.g., a radar module, a camera sensor, a laser module, an ultrasonic sensor, or any other suitable sensor for monitoring a forward vehicle) that monitors a forward vehicle and determines a distance between the forward vehicle and the host vehicle on which the system is employed. In one embodiment, the forward sensor is a radar sensor that generates a “track list” of forward object that the collision warning module reviews with regard to forward vehicle speed, acceleration, etc. The distance information is received by the CWM 18, which executes a collision probability module 22 that calculates a probability of a collision between the host vehicle and the forward vehicle as a function of the distance information and the relative speeds and acceleration/deceleration of the host and forward vehicles. If the probability of a collision is above a predetermined threshold, then the CWM 18 triggers an alert module 24 to emit a signal (e.g., a sound, a light, or the like) to the driver to alert the driver to the potential collision.

Regardless of the probability of the collision, the CMW 18 executes a deceleration calculation module 26 that calculates a deceleration request value that will cause the host vehicle to stop safely if necessary based on the distance information and relative speeds and acceleration/decelerations of the host and forward vehicles. The deceleration calculation module 26 constantly computes a braking force required to mitigate a collision with the currently-monitored forward vehicle. The braking force computation takes into account the relative accelerations of the vehicles and range between the host vehicle and forward vehicle. If there is no current forward vehicle, then the braking force is set to a zero value. In this manner, when the computed braking force is above a given threshold or the system determines that a collision is probable then the braking system is mechanically and/or electrically prepared for activation and the driver is warned.

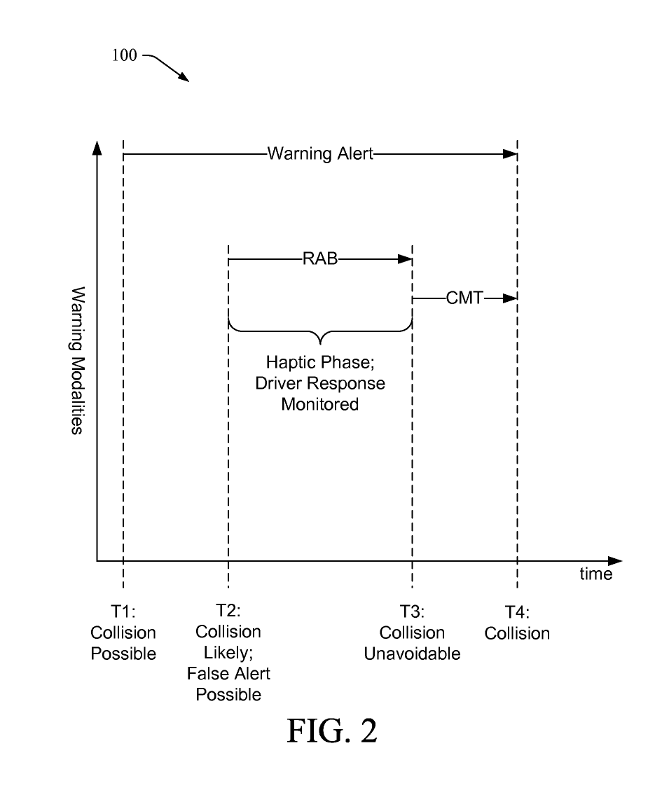

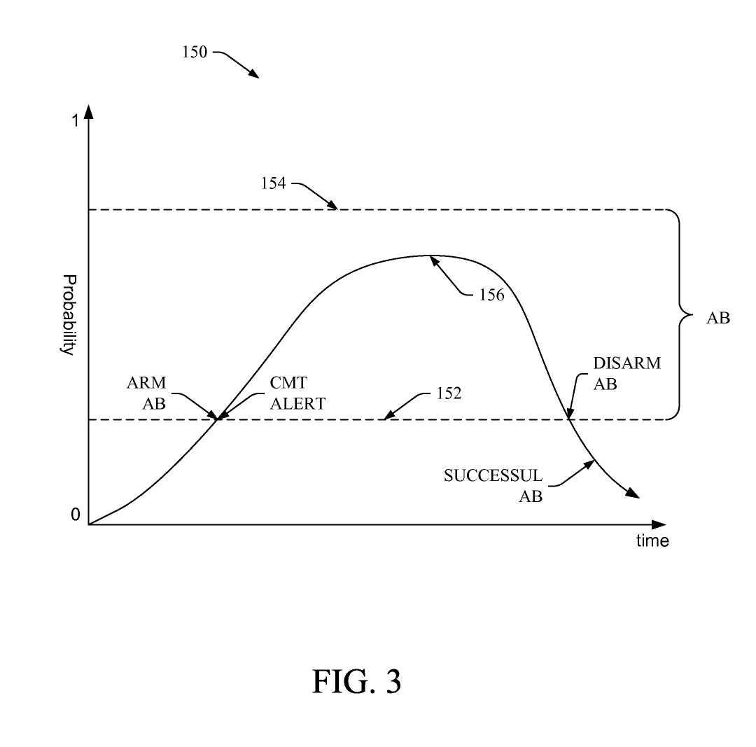

The deceleration request value is transmitted by the CWM 18 to the brake force module 12, which relays the value to an antilock brake system 28 (ABS) for storage in a memory cache 30. This value is calculated (e.g., every 10 ms-25 ms or periodically) and transmitted to the ABS 28. The ABS 28 is also instructed to arm the braking system (including charging) in response to a high probability of collision. To this end, the ABS module comprises an assisted braking software module 31 that arms and/or charges a braking system when collision probability is within an assisted braking range (described in greater detail with regard to FIGS. 2 and 3). The probability of collision is determined not only the based on range and relative velocity of the host and forward vehicles, but also their relative acceleration. Once the brake system is armed, the brake pedal no longer modulates the braking force applied, but rather acts as a signal telling the ABS 28 to determine whether to apply the cached deceleration value or the pedal amount when braking

When the driver depresses a brake pedal 32, the ABS 28 detects (e.g., via a J1939 bus) a brake pedal engagement signal and executes a comparator module 34 that determines whether the amount of braking requested by the brake pedal depression is equal to or greater than the calculated deceleration value. If so, then the brake pedal signal is executed by the ABS 28. If the amount of braking requested by the brake pedal depression is less than the calculated amount, then the ABS 28 to applies the calculated deceleration request value.

In this manner, the braking system 36 is activated using the pre-computed amount (the calculated deceleration request value) to safely slow the vehicle to mitigate the collision. The required braking input is pre-computed and “cached” in the system (e.g., in an antilock brake system (ABS) memory or the like) for immediate activation by the driver upon engaging the brake pedal. The amount of braking supplied is the cached amount if the braking requested by the driver is less than the cached amount. If the driver does not respond to the collision alert by engaging the brake pedal, the collision may become imminent and a collision mitigation (CMT) intervention braking is activated. Thus, the braking system is prepared for immediate activation to a level already determined to mitigate a collision.

According to one embodiment, the requested deceleration value is a running average of a most recent N cached deceleration values, where N is an integer (e.g., 3, 10, etc.). In another embodiment, the cached deceleration value is a minimum deceleration value, and the deceleration value requested upon detection of brake pedal engagement is greater than the cached value (e.g., 105% of the cached value or some other pre-selected percentage).

With continued reference to FIG. 1, FIG. 2 illustrates a graph 100 of warning modalities plotted against collision probability as it increases with time, in accordance with one or more features described herein. The system of FIG. 1 provides rapid and correct application of the brake once a collision alert (ICA) is issued, for example by the alert module 24 upon receiving an indication from the collision probability module 22. The collision warning module 18 determines whether emergency braking is required, and the driver is alerted of a probable collision via the alert module 24 while the ABS 28 is told to pre-charge the brakes and cache the braking force value. This system can be used in the span of time wherein a collision is possible but not certain. In one embodiment, the system relies partially on the action of the driver to close the loop and apply the brake, rather than automatic braking

There are three types of collision probabilities represented in FIG. 2: collision possible; collision likely without evasive maneuvers; and collision unavoidable. In one embodiment, the classification of these collision probabilities is based on one or more of the target's credibility, relative velocity, and acceleration to that of the host vehicle, the target's distance, and the host vehicle's weight, brake wear, traction control, wheel slippage, etc.

At T1, a possible collision is detected. For instance, the CWM 18 FIG. 1) may determine that a collision probability is above a first predetermined probability threshold (e.g., 10%, 25%, or some other predetermined percentage), and the alert module 24 (FIG. 1) is activated to alert the driver to the potential collision (e.g., via a visible and/or audible signal). At T2, the probability of collision exceeds a second predetermined probability threshold (which is higher than the first predetermined threshold), upon which a radar-assisted braking (RAB) charging protocol is executed whereby the ABS control module 28 (FIG. 1) charges the brake system 36 (FIG. 1) so that it is ready to execute a deceleration request for the cached deceleration value upon detection of a signal from the brake pedal 32 (FIG. 1). During this phase and up until T3, driver response (e.g., brake pedal engagement) is monitored and the cached value in the ABS control module is continuously updated. In one embodiment, haptic feedback is provided to the driver (e.g., via the brake pedal, etc.) to alert the driver to a need to engage the brake pedal.

At T3, the probability of collision exceeds a third predetermined threshold, which is higher than the second predetermined threshold, upon which collision between the host vehicle and the forward vehicle is determined to be unavoidable. At this point, if the driver has not engaged the brake pedal, a collision mitigation (CMT) signal is sent form the ABS module 34 to the braking system 36 to take over deceleration and control of the braking system to stop the vehicle before the collision occurs at T4.

With continued reference to FIG. 1, FIG. 3 is a graph 150 showing how collision probability is used to arm, trigger, and/or disarm the braking system 36 (FIG. 1), in accordance with one or more features described herein. The braking system is “armed” when the probability of a collision rises to a preset and configurable level. When the braking system 36 is armed via the assisted braking module 31, feedback is provided to the driver (e.g., visible feedback, haptic feedback, etc.). In the assisted braking zone AB between collision probability thresholds 152 and 154, the braking system is charged and ready for braking and the pre-computed deceleration value is stored in the ABS control module. In FIG. 3, the lower collision probability threshold 152 is approximately 25% probability, and the upper collision probability threshold 154 is approximately 75% probability, although the described systems and methods are not limited to these threshold levels. The brake pedal acts as a signal to the ABS control module to brake to the pre-computed amount when the brake pedal is depressed. The forward sensor and CWM do not intervene with the brake pedal engagement signal when the AB mode is active: rather, the brake force module 12 sends feedback to the driver and a deceleration value to the ABS control module 28. The AB mode is armed and disarmed on the ABS control module 28 based on commands from the brake force module 12.

According to the graph 150, collision probability is monitored. When collision probability exceeds the first probability threshold 152, the assisted braking mode is armed. The CMT alert begins at the Arm AB threshold 152. An initial alert signal may be a visible alert. However, if the driver does not engage the brake pedal and collision probability rises then a collision mitigation (CMT) alert progresses and additional alerts are provided to the driver (e.g., a visible alert, an audible alert, haptic feedback, etc.) is presented to the driver. However, when the driver responds to the CMT alert by engaging the brake pedal at approximately 156, the cached deceleration value is requested and the braking system is activated to supply the requested deceleration amount to slow the host vehicle and reduce the probability of collision. Once the collision probability decreases below the first collision probability threshold 152, the assisted braking mode is deactivated. At line 154, the CMT braking takes over and does not take into account the brake pedal signal in order to mitigate the collision.

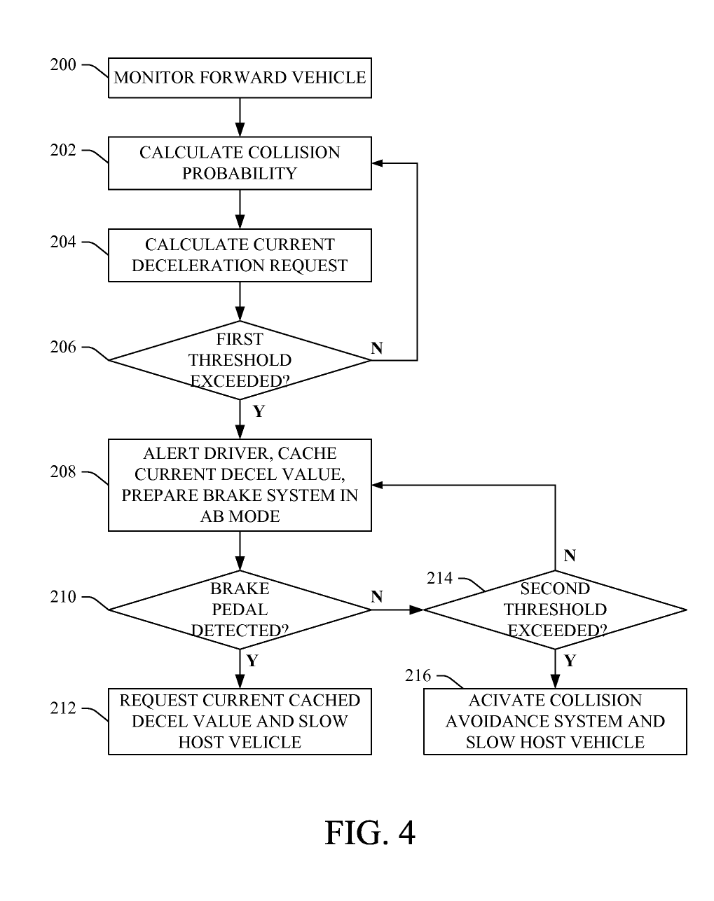

FIG. 4 illustrates a method for mitigating collisions between vehicles by continuously caching a current deceleration request value for execution upon detection of an probable collision and an insufficient brake pedal signal, in accordance with various aspects set forth herein. At 200, a forward vehicle is tracked (e.g., using radar, laser, camera, ultrasonic sensor, etc.) and monitored to determine distance between the host vehicle and the forward vehicle and relative acceleration between the host and forward vehicles. At 202, a probability of collision is calculated as a function of the monitored distance and acceleration. At 204, a deceleration request value describing an amount of deceleration required to safely stop the host vehicle as a function of the monitored distance and acceleration information is calculated using real-time distance and relative acceleration information. At 206, a determination is made regarding whether the probability of collision has exceeded a first predetermined threshold. If not, then the method reverts to 202 for continued monitoring of the forward vehicle.

If the determination at 206 is positive, then at 208, the driver is alerted to the potential collision, a current calculated deceleration request value is continuously transmitted to an antilock brake system (ABS) where it is continuously stored and updated in a cache memory, and the ABS enters assisted braking (AB) mode and charges a braking system to a level sufficient to supply the current deceleration value. At 210, a determination is made regarding whether a brake pedal engagement has been detected. If the determination at 210 is positive, then at 212 the cached deceleration request value is requested and the braking system is engaged to supply the requested amount of braking force to safely slow the host vehicle.

If no brake pedal engagement is detected at 201, then at 214, a determination is made regarding whether the probability of collision has exceeded a second predetermined probability threshold, which is higher than the first threshold. If not, then the method reverts to 210. If the second predetermined collision probability threshold has been exceed, then at 216, a collision avoidance system is activated and the vehicle is stopped. The collision avoidance system may employ the currently cached deceleration request value or any other suitable deceleration amount.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

Having thus described the preferred embodiments, the invention is now claimed to be:

1. A system that facilitates mitigating collisions between a host vehicle and a forward vehicle by caching a current deceleration request value for execution upon detection of an probable collision and an brake pedal signal, comprising:
a forward sensor configured to monitor the forward vehicle;
a brake force determination module comprising:
a collision warning module configured to calculate a probability of a collision between the host vehicle and the forward vehicle as a function of real-time data received from the forward sensor and determine whether the calculated collision probability is above a first predetermined threshold; and
a deceleration calculation module configured to generate a deceleration request value indicative of a brake force sufficient to mitigate the collision as a function of the calculated collision probability; and
wherein the brake force determination module transmits a current deceleration request value to an antilock braking system controller, where the current deceleration request value is cached for execution upon detection of the brake pedal engagement.

2. The system according to claim 1, wherein the forward sensor is a radar sensor that determines a distance between the forward vehicle and the host vehicle and a relative acceleration between the host vehicle and the forward vehicle, and transmits real-time distance and relative acceleration information to the brake force determination module.

3. The system according to claim 1, wherein the forward sensor is one or more of a radar sensor, a camera, an ultrasonic sensor, and a laser sensor.

4. The system according to claim 1, further comprising a comparator module that compares a deceleration request value requested in the detected brake pedal engagement signal to the current calculated deceleration request value, and upon determining that the calculated deceleration request value is greater than the deceleration request value indicated by the brake pedal engagement signal, and instructs the antilock braking system controller to execute the calculated deceleration request value.

5. The system according to claim 1, wherein the antilock brake system controller immediately executes the current cached deceleration request value upon detection of the brake pedal engagement signal when the collision probability is greater than the first determined threshold.

6. The system according to claim 1, wherein the collision warning module sends an alert message to activate an alert module, which alerts the driver to a potential collision, upon determining that the collision probability is above the first predetermined threshold.

7. The system according to claim 1, wherein the brake force determination module sends a command to the brake pedal to provide haptic feedback via the brake pedal upon the collision warning module determining that the collision probability is above the first predetermined threshold.

8. A device that facilitates mitigating collisions between a host vehicle and a forward vehicle, comprising:
a collision warning module configured to calculate a probability of a collision between the host vehicle and the forward vehicle as a function of real-time data received from a forward sensor and determine whether the calculated collision probability is above a first predetermined threshold; and
a deceleration calculation module configured to generate a deceleration request value indicative of a brake force sufficient to mitigate the collision as a function of the calculated collision probability; and
a processor that transmits a current deceleration request value to an antilock braking system controller, where the current deceleration request value is cached for execution upon detection of the brake pedal engagement.

9. The device according to claim 8, wherein the device receives from the forward sensor real-time information indicating a distance between the forward vehicle and the host vehicle and a relative acceleration between the host vehicle and the forward vehicle.

10. The device according to claim 8, wherein the forward sensor is one or more of a radar sensor, a camera, an ultrasonic sensor and a laser sensor.

11. The device according to claim 8, wherein the antilock braking system controller comprises a comparator module that compares a deceleration request value requested in the detected brake pedal engagement signal to the current calculated deceleration request value, and upon determining that the calculated deceleration request value is greater than the deceleration request value indicated by the brake pedal engagement signal, instructs the antilock braking system controller to execute the calculated deceleration request value.

12. The device according to claim 8, wherein the antilock brake system controller immediately executes the current cached deceleration request value upon detection of the brake pedal engagement signal when the collision probability is greater than the first determined threshold.

13. The device according to claim 8, wherein the collision warning module sends an alert message to activate an alert module, which alerts the driver to a potential collision, upon determining that the collision probability is above the first predetermined threshold.

14. The device according to claim 8, wherein the processor sends a command to the brake pedal to provide haptic feedback via the brake pedal upon the collision warning module determining that the collision probability is above the first predetermined threshold.

15. A method of mitigating collisions between a host vehicle and a forward vehicle, comprising:
monitoring a forward vehicle;
calculating a probability of a collision between the forward vehicle and the host vehicle;
calculating a deceleration request value indicative of a braking force sufficient to mitigate the collision;
transmitting current deceleration request values to an antilock braking system (ABS) controller for storage in a memory cache in the ABS controller;
determining whether a first collision probability threshold has been exceeded;
upon determining that the first collision probability threshold has been exceeded, determining whether a brake pedal engagement signal has been detected;
upon detection of the brake pedal engagement signal, executing a braking request using the cached deceleration request value.

16. The method according to claim 15, wherein the probability of collision is calculated as a function of real-time data indicative of a distance and relative acceleration between the host and forward vehicles.

17. The method according to claim 15, further comprising, upon a determination that a brake pedal engagement signal has not been detected, determining whether a second collision probability threshold has been exceeded, the second collision probability threshold being higher than the first collision probability threshold; and upon determining that the second collision probability threshold has been exceeded, initiation a collision mitigation protocol.

18. The method according to claim 15, further comprising, upon determining that the first collision probability threshold has been exceeded charging a braking system to a level sufficient to supply braking force consistent with the deceleration request value cached in the ABS controller.

19. An apparatus that facilitates mitigating collisions between a host vehicle and a forward vehicle, comprising:
brake controller means for detecting a brake pedal engagement signal;
collision probability calculation means for calculating a probability of a collision between the host vehicle and the forward vehicle as a function of real-time data received from a forward sensor and for determining whether the calculated collision probability is above a first predetermined threshold; and
deceleration calculation means for generating a deceleration request value indicative of a brake force sufficient to mitigate the collision as a function of the calculated collision probability; and
processing means that transmits a current deceleration request value to the brake controller means, where the current deceleration request value is cached for enforcement upon detection of the brake pedal engagement signal.
